(19) United States
(12) Patent Application Publication
(10) Pub. No.: US 2026/0272149 A1
(43) Pub. Date: Sep. 17, 2026

(54) Back of Hand Mounting System

(71) Applicant: Zebra Technologies Corporation, Lincolnshire, IL (US)

(72) Inventors: Sunghun Lim, Bethpage, NY (US); Chandra M. Nair, Mount Sinai, NY (US); Heesang Ahn, Queens, NY (US); Irfan Kadri, Mississauga (CA); Xinghua Shi, Milton (CA); Bo Xu, Mississauga (CA); Jake Emerson John Blimkie, Toronto (CA); Kenneth W. Taylor, Toronto (CA)

(73) Assignee: Zebra Technologies Corporation, Lincolnshire, IL (US)

(21) Appl. No.: 19/667,581

(22) Filed: May 4, 2026

Related U.S. Application Data
(63) Continuation of application No. 19/016,593, filed on Jan. 10, 2025.
Application No. 19/016,593 is a continuation of application No. PCT/US25/10973, filed on Jan. 9, 2025.
(60) Provisional application No. 63/620,563, filed on Jan. 12, 2024.

(51) Int. Cl. A45F 5/00; G06K 7/10

(52) U.S. Cl. CPC A45F 5/00; A45F 2005/008; G06K 2007/10534

(57) ABSTRACT

A hand mount for a data capture device having an optical axis includes: a body configured to rest on a back of a hand of an operator; a mounting plate affixed to the body, the mounting plate defining a longitudinal axis; a latch assembly coupled to the mounting plate, the latch assembly configured to releasably secure the data capture device with the optical axis parallel with the longitudinal axis of the mounting plate; a proximal wing extending from a proximal end of the body, the proximal wing defining a proximal fastener configured to engage with a wrist of an operator; a distal wing extending from a distal end of the body at a nonparallel angle to the longitudinal axis, the distal wing configured to engage with a finger of the operator; and a trigger disposed on the distal wing.

### CROSS-REFERENCE TO RELATED APPLICATIONS

This application is a continuation of U.S. Patent Application Serial Number 19/016,593, filed on Jan. 10, 2025, which claims priority from U.S. Provisional Patent Application Serial Number 63/620,563 filed on Jan. 12, 2024, both of which are incorporated herein by reference in their entirety.

### BACKGROUND

Finger or hand-mounted electronic devices, such as data capture devices, can be used to capture barcodes and the like, e.g., for transmission to a computing device carried by the operator. Accessories to attach such devices to an operator's hand, however, may be cumbersome to apply and/or operate.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an example hand mount for a data capture device.

FIG. 2 is a diagram showing the data capture device of FIG. 1 from below and from the rear.

FIG. 3 is a diagram illustrating a top view of the hand mount and device of FIG. 1.

FIG. 4 is a diagram illustrating a top view of the hand mount and device of FIG. 1, when worn by an operator.

FIG. 5 is a diagram illustrating a perspective view of another example hand mount.

FIG. 6 is a diagram showing another example data capture device, for use with the hand mount of FIG. 5, from below and from the front.

FIG. 7 is a diagram illustrating a perspective view of the mounting plate of the hand mount of FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to a hand mount for a data capture device having an optical axis, the hand mount comprising: a body configured to rest on a back of a hand of an operator; a mounting plate affixed to the body, the mounting plate defining a longitudinal axis; a latch assembly coupled to the mounting plate, the latch assembly configured to releasably secure the data capture device with the optical axis parallel with the longitudinal axis of the mounting plate; a proximal wing extending from a proximal end of the body, the proximal wing defining a proximal fastener configured to engage with a wrist of an operator; a distal wing extending from a distal end of the body at a nonparallel angle to the longitudinal axis, the distal wing configured to engage with a finger of the operator; and a trigger disposed on the distal wing.

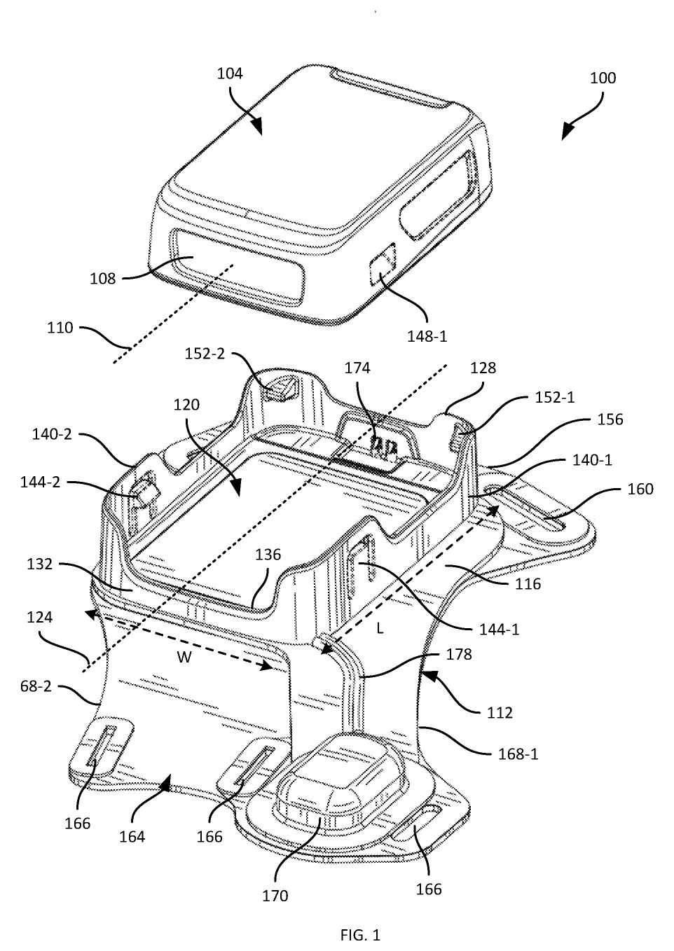

FIG. 1 depicts a system 100 to enable hand-mounted operation of an electronic device, such as a data capture device 104. The data capture device 104, in the present example, is a barcode scanner and includes a data capture assembly (e.g., an image-based barcode scanner including one or more image sensors) enabling the data capture device 104 to capture barcodes via a scan window 108. Other electronic devices can also be employed in the system 100, such as radio frequency identification (RFID) readers, cameras, range finders, and the like.

The data capture device 104, in this example, has an optical axis 110, e.g., representing the center of a field of view of the barcode scanning module of the device 104. The optical axis 110, in this example, extends perpendicularly to the scan window 108, e.g., from the center of the scan window 108.

The system 100 also includes a hand mount 112 (also referred to as the mount 112, or as an accessory 112) to removably couple the data capture device 104 to a back of an operator’s hand (e.g., the dorsal side of the hand, opposite the palm). As will be apparent to those skilled in the art, various accessories may be employed to fasten a data capture device to an operator’s hand. For example, a glove with a device holder on the back thereof may be used. However, such an implementation may require the provision of multiple sizes of glove to accommodate different hand sizes between users. Further, gloves place material over the palm of the operator, where such material is prone to excessive wear and may cause discomfort (e.g., due to heat, chafing and the like) to the operator. Other accessories, e.g., palm-free accessories extending between a strap around the operator’s wrist and a strap around the operator’s index finger, may mitigate the issues noted above with respect to material over the operator’s palm, but may also place the device 104 at an angle that results in the optical axis 110 being aimed in an awkward direction relative to the operator’s hand (e.g., angled radially, towards the thumb, rather than substantially parallel to the operator’s forearm).

The mount 112, as discussed below, includes various structural features enabling mounting of the data capture device 104 without placing material over the operator’s palm, and while angling the device 104 such that the axis 110 is substantially parallel with the operator’s forearm for intuitive aiming. In addition, the mount 112 includes certain structural features enabling toolless attachment and removal of the device 104 by an operator, while mitigating against accidental detachment of the device 104 from the mount 112, e.g., from catching on garments or other objects.

The mount 112 includes a body 116 configured to rest on a back of a hand of an operator. The body 116 can be formed from one or more layers of flexible material, e.g., a textile or composite such as textile-lined neoprene. The mount 112 further includes a mounting plate 120 affixed to the body 116. The mounting plate 120 can be a relatively rigid (e.g., compared to the material of the body 116) plate formed from plastic or other materials suitable for retaining the device 104. The mounting plate 120 can be affixed to the body 116 by adhesives, stitching, or a combination thereof. The mounting plate 120 defines a longitudinal axis 124, e.g., parallel to a length “L” of the mounting plate 120 and perpendicular to a width “W” of the mounting plate 120. The mount 112 is configured to orient the mounting plate 120, when the mount 112 is worn by an operator, such that the longitudinal axis 124 extends from the wrist of the operator towards the fingers (e.g., the middle finger) of the operator. Further, as seen in FIG. 1, the longitudinal axis 124 and the optical axis 110 are substantially parallel when the device 104 is received by the mounting plate 120. In some examples, the longitudinal axis 124 and the optical axis 110 are substantially coaxial when the device 104 is received by the mounting plate 120.

The mount 112 further includes a latching assembly coupled to the mounting plate 120. In this example, the mounting plate 120 is a substantially planar plate affixed to the body 116, and the mount 112 further includes a set of walls extending from the mounting plate 120 to define a volume for receiving the device 104. In the example illustrated in FIG. 1, the mount 112 includes a rear wall 128 and an opposing front wall 132 extending substantially perpendicularly from the mounting plate 120. The front wall 132 can include an opening 136 therein, e.g., in the form of a cutout, to accommodate the scan window 108 (e.g., to avoid obstructing the field of view of the device 104).

The mount 112 can also include opposing side walls 140-1 and 140-2 (collectively referred to as the side walls 140; similar nomenclature is used for other components herein), extending between the rear wall 128 and the front wall 132. The latching assembly mentioned above can include at least one resilient tab. In this example, the latching assembly includes two resilient tabs 144-1, and 144-2, each disposed on a respective one of the walls 140-1 and 140-2. The tabs 144 are integrally formed with the walls 140 in this example, e.g., separated from the corresponding wall 140 on three sides and joined with the corresponding wall 140 at the bottom. The tabs 144 can be biased inwards (as shown in FIG. 1), to engage with a respective recess 148-1 on the device 104, to retain the device 104 against the mounting plate 120.

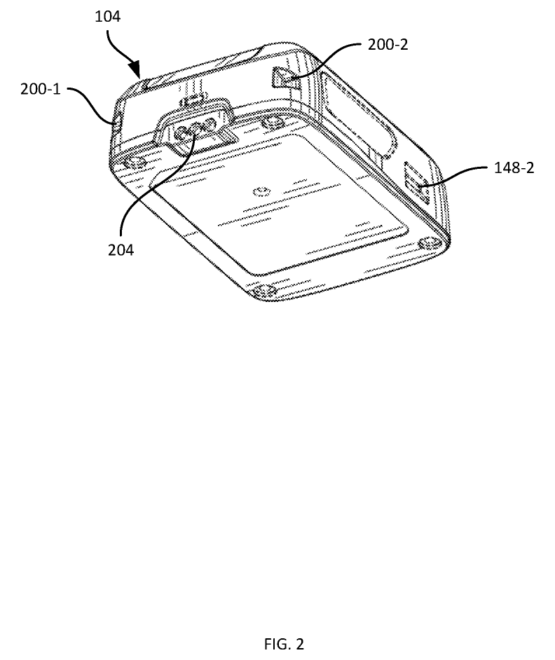

The latching assembly can also include at least one hook 152 (in this example, two hooks 152-1 and 152-2) extending into the volume defined by the walls 128, 132, and 140. The hooks 152 extend, in this example, from the rear wall 128. The device 104 includes complementary structures, discussed below in connection with FIG. 2, that engage with the hooks 152. Insertion and removal of the device 104 onto the mount 112 is discussed further below, following the discussion of FIG. 2.

The mount 112 further includes a proximal wing 156 extending from a proximal end of the body 116. The term “proximal”, in this discussion, corresponds to a position or component closer to a wrist of the operator when the mount 112 is worn, while the term “distal” corresponds to a position or component closer to a finger, e.g., an index finger, of the operator when the mount 112 is worn. The proximal wing 156 defines a fastener configured to engage with a wrist of the operator, e.g., via one or more apertures 160 to accommodate a strap or other fastening member (not shown).

The mount 112 also includes a distal wing 164 extending from a distal end of the body 116 and defining a fastener configured to engage with an index finger of the operator. The fastener can be defined via one or more apertures 166 configured to receive a strap or other fastening member (not shown). The distal wing 164 has a width that is substantially equal to the width W of the body 116 in this example. The width of the distal wing 164 is therefore larger than a width of the mounting plate 120.

The distal wing 164 thus includes opposing sides or edges 168-1 and 168-2 that extend from corresponding sides of the body 116, and is configured to wrap onto the operator’s index finger. For example, the edge 168-2 can be configured to lie along an inside (e.g., towards the middle finger) or bottom (e.g., towards the palm) of the index finger when the mount 112 is worn. The edge 168-1 can be configured to lie along the outside (e.g., towards the thumb) of the index finger when the mount 112 is worn.

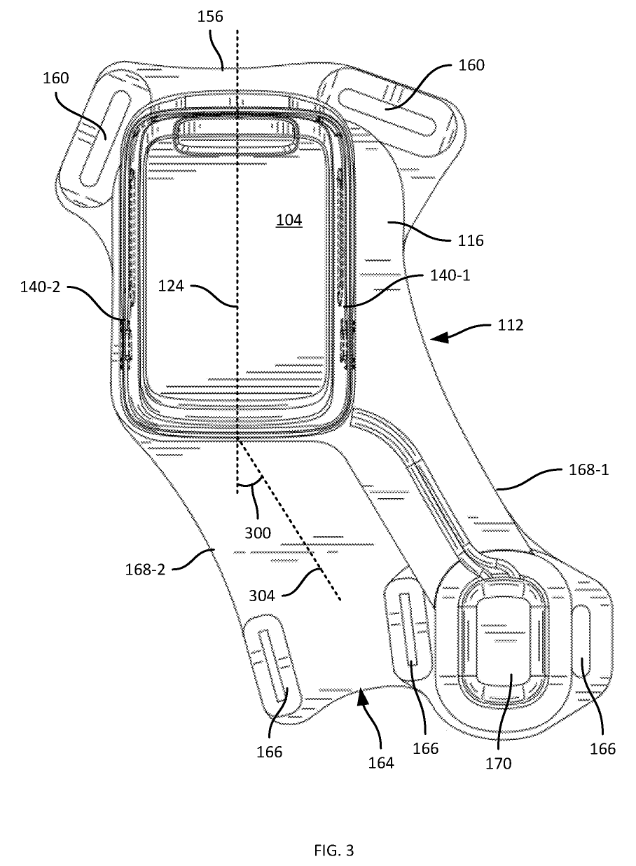

The edges 168, and the distal wing 164 as a whole, are at a nonparallel angle relative to the longitudinal axis 124 of the body 116, as shown more clearly in FIG. 3, discussed further below. The angle at which the distal wing 164 extends from the body 116 enables the device 104 to be positioned to aim the optical axis 110 substantially parallel with the forearm of the operator (e.g., and/or the middle finger of the operator).

The mount 112 further includes a trigger 170 disposed on the distal wing 164, e.g., adjacent to the edge 168-1. The positioning of the trigger 170 on the distal wing 164 places the trigger 170 on the radial side (e.g., towards the thumb) of the index finger when the mount 112 is worn, permitting activation of the trigger 170 with the thumb. The trigger 170 is shown as a button in this example, but can also include a touch sensor (e.g., a capacitive sensor) or other suitable tactile inputs in other examples.

The trigger 170 is electrically connected with a set of contacts 174 disposed in the volume defined by the mounting plate 120 and the walls 128, 132, and 140. In this example, the contacts 174 are disposed on the rear wall 128, but in other embodiments the contacts 174 can be disposed on another wall. The contacts 174 are configured to engage with corresponding contacts on the device 104, to electrically connect the trigger 170 with the device 104. The trigger 170 can then be operated to initiate a data capture operation at the device 104. The mount 112 can include electrical conduits 178 extending from the trigger 170 to the contacts 174. In some examples, the conduits 178 can be embedded within the distal wing 164 and the body 116 while remaining loose and flexible within the fabric layers for extensibility. The conduits 178 may not be visible from the exterior of the mount 112. In the example shown in FIG. 1, the conduits 178 travel along an upper surface of the distal wing 164 towards the mounting plate 120. In an alternate embodiment, conductive fabric (instead of the conduits 178) is used to carry electrical signals between the trigger 170 and device contacts 204. The conduits 178 can be implemented as one or more cables, one or more wires (e.g., disposed loosely between layers of fabric), one or more flexible circuit traces and/or cables, metal-impregnated fabric, a wire mesh extending through at least a portion of the body 116, or the like.

FIG. 2 shows the device 104 from the rear, and the opposite side shown in FIG. 1. As seen in FIG. 2, in addition to a recess 148-2 on the opposite side of the device 104 from the recess 148-1, the device 104 includes indents 200-1 and 200-2, configured to engage with the hooks 152-1 and 152-2, respectively. The device 104 also includes contacts 204 complementary with the contacts 174, and configured to electrically connect the trigger 170 with a controller or other hardware element of the device 104. In an alternate embodiment, the mounting plate 120 includes the recesses and the indents, while the device 104 includes the corresponding resilient tabs and hooks. In the illustrated embodiment of FIG. 2, the contacts 204 are disposed at the rear wall of the device 104. In an alternate embodiment, contacts 204 are disposed on another wall of the device 104, matching a corresponding alternate location of contacts 174 on an alternate wall of the mounting plate 120.

In the illustrated embodiment, the device 104 can be coupled to the mount 112 by placing the rear of the device 104, shown in FIG. 2, against the rear wall 128 of the mount 112, while the front of the device 104 (with the scan window 108) is angled upwards away from the mounting plate 120. Placement of the rear portion of the device 104 into the volume defined by the mounting plate 120 and the walls 128, 132, and 140 engages the contacts 204 with the contacts 174, and engages the indents 200 with the hooks 152. The forward portion of the device 104 can then be pressed downwards, causing the tabs 144 to flex outwards to permit passage of the bottom of the device 104. When the device 104 lies against the mounting plate 120, the tabs 144 engage with the recesses 148. The tabs 144 and the hooks 152 thus retain the device 104 against the mounting plate 120.

To remove the device 104 from the mount 112, an operator can grasp a front of the device 104, e.g., above the scan window 108, and pull upwards, away from the mounting plate 120. The tabs 144 may deform outwards, releasing the device 104, before returning to the resting position shown in FIG. 1. When the recesses 148 are clear of the tabs 144 and forward portion of the device 104 is above the walls 132 and 140, the device 104 may then be withdrawn in a forward direction from the mount 112, disengaging the hooks 152 from the indents 200.

FIG. 3 illustrates a top view of the mount 112 with the device 104, illustrating an angle 300 between the longitudinal axis 124 (which may coincide with the optical axis 110 when the device 104 is mounted) and the distal wing 164. For example, the distal wing 164 may have a longitudinal axis 304 substantially parallel with the edges 168. The longitudinal axis 304 is angled relative to the longitudinal axis 124, such that the channel formed by the distal wing 164 when the distal wing 164 wraps onto the index finger of the operator is offset relative to the axis 124. The angle 300 is about 30 degrees in this example, but it will be understood by those skilled in the art that various other nonparallel angles 300 can be employed.

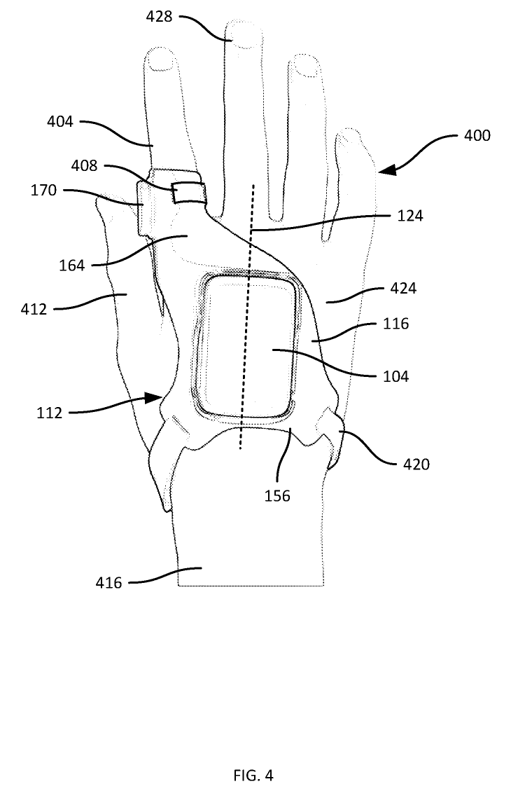

Turning to FIG. 4, the mount 112 is shown worn on a hand 400 of an operator. The distal wing 164 is wrapped at least partially around an index finger 404, e.g., fastened with a strap 408 or the like (e.g., including a buckle, hook and loop fastening, or other suitable fastening mechanisms) extending through the apertures 166. In other examples, the distal wing 164 can form a loop, e.g., of elastic mesh or other suitably flexible material that can fit over the index finger 404, e.g., expanding to accommodate various finger sizes. The edges 168 thus lie along the radial and ulnar sides of the index finger 404, or along the bottom (e.g., the palm side) of the index finger 404. The trigger 170 is disposed along the radial side of the index finger 404, for activation by the thumb 412 of the operator. In other examples, the trigger 170 can be disposed in other positions relative to the index finger 404, e.g., on the fingertip of the index finger 404 for activation by the thumb 412. The proximal wing 156 is fastened to a wrist 416 of the operator, e.g., with a strap 420 or the like extending through the apertures 160. The mount 112 is therefore secured to a back 424 of the hand 400.

As seen in FIG. 4, when the mount 112 is worn, the longitudinal axis 124 (and therefore the optical axis 110) is substantially parallel with a middle finger 428 of the operator, which is generally parallel with the operator’s forearm. Aiming the device 104 at target objects for data capture operations may therefore be more intuitive for the operator than with a mount that aims the device 104 along a line extending from the wrist 416 to the index finger 404.

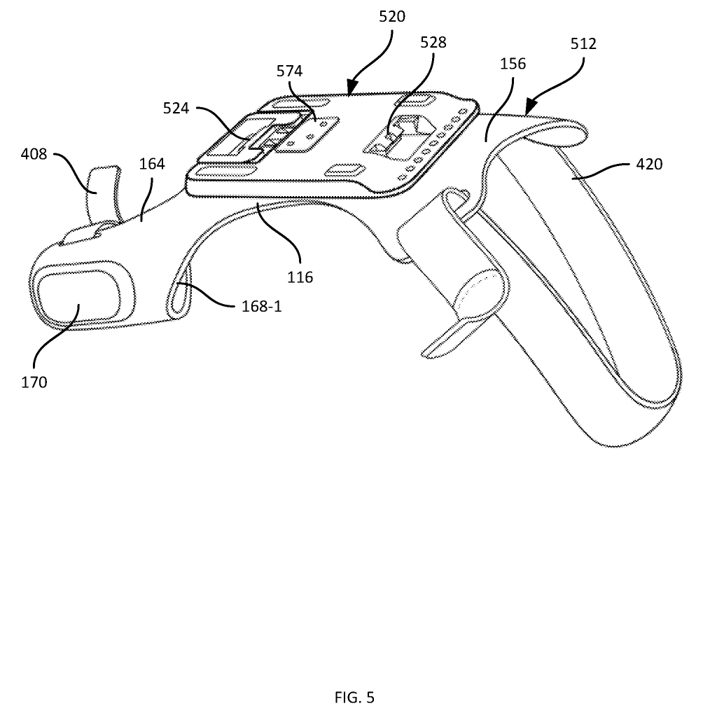

Turning to FIG. 5, a mount 512 is illustrated according to another embodiment. The mount 512 includes a body 116 and wings 156 and 164 as discussed above. The mount 512 is shown in a worn configuration, omitting the hand 400, such that the edge 168-1 can be seen wrapping around the radial side of the index finger 404 and, in this example, underneath the index finger 404. The mount 512 includes a mounting plate 520 affixed to the body 116 that includes a latching assembly and electrical contacts that are structurally distinct from those of the mount 112. The mount 512, for example, omits walls extending substantially perpendicularly from the mounting plate 520. The mounting plate 520 includes electrical contacts 574, e.g., in a central portion of mounting plate 520, rather than on a rear wall as discussed earlier. Further, the latching mechanism implemented by the mount 512 is defined by features of the mounting plate 520 rather than features of walls extending therefrom. In particular, the mounting plate 520 supports a movable latch 524, and a static latch 528.

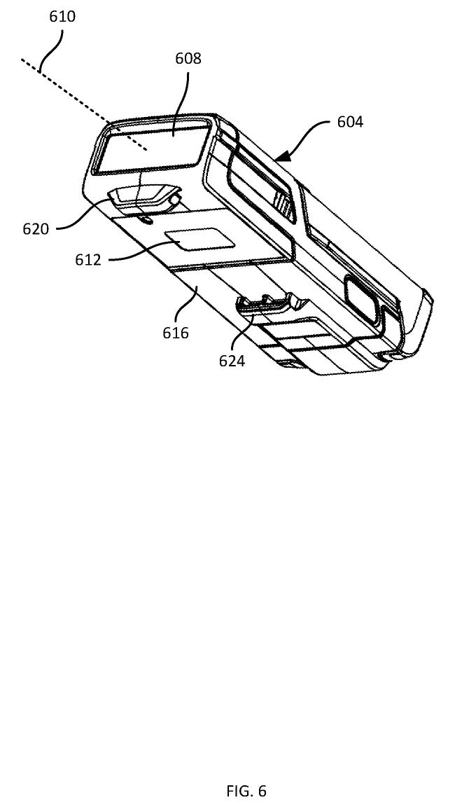

Turning to FIG. 6, a data capture device 604 is shown from the bottom. The data capture device includes a scan window 608 and an optical axis 610, which are functionally similar to the scan window 108 and optical axis 110. The device 604 further includes contacts 612 disposed on a bottom portion 616 of the device, e.g., rather than at a rear of the device as in the case of the device 104. In an alternate embodiment, the device 604 may have contacts at its rear wall and/or sidewall and the mounting plate 520 may also have a rear wall and/or sidewall with matching contacts. The device 604 further includes a forward hook 620, and a rear hook 624 on the bottom portion 616. The mount 512 is configured to releasably secure the device 604 to the hand 400.

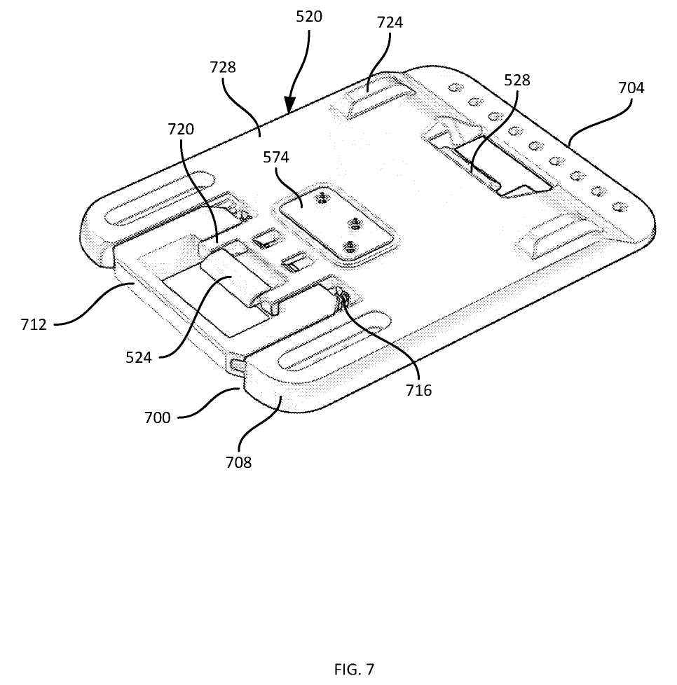

FIG. 7 shows the mounting plate 520 in greater detail. The movable latch 524 is disposed adjacent to a forward end 700 of the mounting plate 520, while the static latch 528 is disposed adjacent to a rear end 704 of the mounting plate 520. The movable latch 524 is movable between an extended position, shown in FIG. 7, to retain the device 604 against the mounting plate 520, and a retracted position to release the device 604 from the mounting plate 520. In the retracted position, the movable latch 524 is displaced in the same plane as the mounting plate 520 towards the rear end 704, thus reducing the distance between the movable latch 524 and the static latch 528. When the movable latch 524 is in the retracted position, the movable latch 524 may be withdrawn from the hook 620 of the device 604, permitting the device 604 to be removed from the mounting plate 520. When the movable latch 524 is in the extended position, the movable latch 524 extends into the hook 620 while the static latch engages with the hook 624, retaining the device 604.

The mounting plate 520 includes at least one post 708 (in this example, two posts 708 on either side of the latch 524). The posts 708 define the forward end 700 of the mounting plate 520. That is, the posts 708 extend further forward than a forward edge 712 of the latch 524. The posts 708 may therefore reduce the likelihood of the latch 524 being accidentally released by contact with an object, catching on an item of clothing, or the like. To move the latch 524 to the retracted position, the operator may press on the forward edge 712. The latch 524 can be biased towards the extended position, e.g., by one or more springs 716.

The posts 708 can define a space in the mounting plate 520 that accommodates the latch 524. The mounting plate 520 can also include one or more stops 720 extending into such a space. The stops 720 engage with the sides of the hook 620 when the device 604 is coupled to the mounting plate 520, and prevent rearward motion of the device 604. In other words, the stops 720 may prevent accidental release of the device 604 e.g., if the device 604 catches on an object, an item of clothing, or the like.

The mounting plate 520 can include one or more alignment features, such as rails or protrusions 724 extending from an upper surface 728 of the mounting plate 520. The protrusions 724 are configured to align the device 604 on the mounting plate 520, e.g., to abut with opposing sides of the device 604 to align the hook 624 with the static latch 528, and to align the hook 620 with the movable latch 524.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A hand strap for a scanner having an optical axis, the hand strap comprising:
a body configured to rest on a back of a hand of a user;
an attachment clip affixed to the body, the attachment clip defining a longitudinal axis;
two or more alignment apertures defined in the attachment clip, the alignment apertures configured to receive corresponding protrusions on the scanner;
a latch assembly configured to releasably secure the scanner, wherein the protrusions are retained within the alignment apertures when the scanner is secured to the attachment clip, wherein the attachment clip includes the latch assembly;
a wrist wing extending from a proximal end of the body, the wrist wing located on a wrist of the user when worn by the user; and
an index-finger section extending from a distal end of the body, the index-finger section configured to position a trigger button adjacent to a side of an index finger of the user for actuation by a thumb of the user.

2. The hand strap of claim 1, wherein the alignment apertures comprise exactly two alignment apertures.

3. The hand strap of claim 1, wherein the trigger button is disposed adjacent to a thumb-side edge of the index-finger section and wherein the index-finger section extends at a nonparallel angle to the longitudinal axis.

4. The hand strap of claim 1, further comprising:
alignment rails extending from an upper surface of the attachment clip on opposing sides of the longitudinal axis, wherein the alignment rails are configured to guide the scanner onto the attachment clip such that the protrusions are received by the alignment apertures.

5. The hand strap of claim 4, wherein the alignment rails engage only a lower half of a side profile of the scanner.

6. The hand strap of claim 1, further comprising:
exactly two electrical contacts disposed on a proximal side of the attachment clip, the two electrical contacts configured to electrically connect the trigger button with the scanner, wherein the two electrical contacts remain engaged with the scanner when the latch assembly is actuated to release the scanner.

7. The hand strap of claim 1, wherein the attachment clip is a substantially planar plate that omits walls extending substantially perpendicularly therefrom at a height that is greater than a vertical height of a top surface of the scanner.

8. The hand strap of claim 1, wherein the attachment clip is affixed to the body by stitching extending through apertures defined in the attachment clip, wherein said apertures are visible to a user when the scanner is not affixed to the hand strap.

9. The hand strap of claim 1, wherein the latch assembly comprises a latch disposed at a distal end of the attachment clip, wherein the latch assembly is configured to deform at least a portion of the attachment clip to release the protrusions from the alignment apertures.

10. The hand strap of claim 1, wherein a ratio of a length of the attachment clip along the longitudinal axis to a width of the attachment clip perpendicular to the longitudinal axis is at least 1.5:1.

11. A system comprising:
a scanner configured to capture at least one of image data and barcode data, the scanner having an optical axis and comprising protrusions extending from a surface of the scanner; and
a hand strap coupled to the scanner, the hand strap comprising:
a body configured to rest on a back of a hand of a user;
an attachment clip affixed to the body, the attachment clip defining a longitudinal axis;
two or more alignment apertures defined in the attachment clip, the alignment apertures configured to receive the protrusions on the scanner;
a latch assembly configured to releasably secure the scanner, wherein the protrusions are retained within the alignment apertures when the scanner is secured to the attachment clip, wherein the attachment clip includes the latch assembly;
a wrist wing extending from a proximal end of the body, the wrist wing configured to engage with a wrist of the user; and
an index-finger section extending from a distal end of the body, the index-finger section configured to position a trigger button adjacent to a side of an index finger of the user for actuation by a thumb of the user.

12. The system of claim 11, wherein the scanner comprises a capacitive touchscreen configured to emit light to display information.

13. The system of claim 12, wherein the capacitive touchscreen is configured to display information to the user related to the captured data.

14. The system of claim 11, wherein the alignment apertures comprise exactly two alignment apertures.

15. The system of claim 11, wherein the latch assembly comprises a latch disposed at a distal end of the attachment clip, wherein the latch assembly is configured to deform at least a portion of the attachment clip to release the protrusions from the alignment apertures.

16. The system of claim 11, further comprising alignment rails extending from an upper surface of the attachment clip on opposing sides of the longitudinal axis, the alignment rails configured to guide the scanner onto the attachment clip such that the protrusions are received by the alignment apertures.

17. The system of claim 11, further comprising exactly two electrical contacts disposed on a proximal side of the attachment clip, the two electrical contacts configured to electrically connect the trigger button with the scanner, wherein the two electrical contacts remain engaged with the scanner when the latch assembly is actuated to release the scanner.

18. The system of claim 11, wherein the attachment clip is a substantially planar plate that omits walls extending substantially perpendicularly therefrom at a height that is greater than a vertical height of a top surface of the scanner.

19. The system of claim 11, wherein the index-finger section extends at a nonparallel angle to the longitudinal axis.

20. The system of claim 11, wherein the attachment clip is affixed to the body by stitching extending through apertures defined in the attachment clip.
